(19) United States
(12) Patent Application Publication
(10) Pub. No.: US 2012/0042358 A1
(43) Pub. Date: Feb. 16, 2012

(54) Proctoring System

(75) Inventors: Shankar Narayana Kondur, Santa Clara, CA (US); Saurabh Goyal, Bangalore (IN)

(73) Assignee: DevSquare Inc.

(21) Appl. No.: 12/896,921

(22) Filed: Oct. 4, 2010

(30) Foreign Application Priority Data
Aug. 10, 2010 (IN) 2289/CHE/2010

(51) Int. Cl. G06F 21/00

(52) U.S. Cl. 726/3

(57) ABSTRACT

A computer implemented method and system is provided for authenticating and monitoring an examination environment of a user. A proctoring software provided on a user's computing device communicates with a remote monitoring station via a server over a network. A data capture device provided on the computing device is configured to rotate and tilt to multiple angles to view and capture audiovisual data from the examination environment. A proctor administering the remote monitoring station authenticates the user based on an examination selected by the user. The proctor defines criteria comprising actions allowed for the user while taking the examination. The proctoring software monitors the examination environment for conformance to the defined criteria. The proctoring software transmits the monitoring information to the remote monitoring station based on transmission parameters determined by the server. The proctor controls actions of the user when the user is not in conformance with the defined criteria.

### CROSS REFERENCE TO RELATED APPLICATIONS

This application claims the benefit of non-provisional patent application number 2289/CHE/2010 titled “Proctoring System”, filed on Aug. 10, 2010 in the Indian Patent Office.

The specification of the above referenced patent application is incorporated herein by reference in its entirety.

### BACKGROUND

As computers become increasingly pervasive, most students and professionals have access to a computer. Moreover, with the advent of the Internet, wired or wireless classrooms, and the world wide web, educational institutions are now able to provide educational content directly to students' personal computers in an electronic form. Institutions are able to achieve the benefits of computer based learning and testing without having to provide students or trainees with access to school computers, or in some cases even classrooms.

On-line testing is becoming more prevalent as users of data networks realize the potential in obtaining training and education via electronic means. On-line testing precludes the physical presence of the student at a testing location to answer the examination or to benefit from a supervisor's instruction. Some educational institutions provide students with the ability to take examinations via their home computer and a data network. Institutions have adopted computer based systems to make the examination process easier for the students, to facilitate quicker and more accurate examination grading, to provide instant feedback of examination results, to reduce examination preparation time, and to enable the rapid creation of examinations from large databases of examination questions.

While educational institutions and professional certification organizations have begun to realize the logistical and administrative benefits of computer based testing systems, the dispersive nature of this teaching method has created numerous challenges in the examination process. For example, in administering secure examinations such as professional qualification examinations and other such examinations, much time and effort is spent in ensuring the integrity of the examination.

Ensuring the integrity of an examination becomes even more burdensome when the examination is given at a number of remote locations. For example, an examination taker needs to be authenticated to ensure that only persons who are registered for an examination are allowed to take the examination. Moreover, the examinations being taken at remote locations need to be properly proctored to ensure that persons taking the examination do not cheat. Therefore, there is a need for acquiring data, for example, audiovisual data indicative of the examination environment at different angles. Furthermore, there is a need for protecting information and controlling actions being performed in the examination environment to ensure that cheating does not take place. Furthermore, existing systems do not account for load and other transmission parameters that affect the transmission of the collected data.

Hence, there is a need for a computer implemented method and system that authenticates and monitors an examination environment of an examination taker to ensure integrity of the examination process. Furthermore, there is a need for a computer implemented method and system that accounts for load and other transmission parameters for optimizing data transmissions in the examination environment.

### SUMMARY OF THE INVENTION

This summary is provided to introduce a selection of concepts in a simplified form that are further described in the detailed description of the invention. This summary is not intended to identify key or essential inventive concepts of the claimed subject matter, nor is it intended for determining the scope of the claimed subject matter.

The computer implemented method and system disclosed herein addresses the above stated need for authenticating and monitoring an examination environment of a user to ensure the integrity of an examination process. The computer implemented method and system disclosed herein also accounts for load and other transmission parameters for optimizing data transmissions in the examination environment.

A proctoring software is provided on a computing device of the user. The proctoring software communicates with a remote monitoring station via a server over a network. A data capture device, for example, an image capture device, a video capture device, an audio capture device, or any combination thereof, is provided on the computing device of the user. The data capture device is, for example, a webcam, a microphone, a webcam integrated with a microphone, etc. The data capture device is configured to rotate and tilt to multiple angles to view the examination environment and capture audiovisual data from the viewed examination environment. The data capture device comprises a motor for facilitating automatic rotation and tilt of the data capture devices to multiple angles to view the examination environment. The angles for the rotation comprise angles up to about 360 degrees and the angles for tilt comprise angles up to about 180 degrees. The data capture device captures the audiovisual data in the examination environment continuously.

The user selects an examination on an interface provided by the proctoring software. The interface provided by the proctoring software enables the user to access multiple examinations through the proctoring software. A proctor at the remote monitoring station is assigned to the user to monitor the user's examination environment based on the selected examination. The proctoring software connects the user's computing device to the remote monitoring station administered by the proctor via the server. The proctor at the remote monitoring station authenticates the user through the proctoring software based on the selected examination. The proctor defines criteria for the selected examination. The defined criteria comprise, for example, multiple actions allowed for the user while taking the selected examination in the examination environment. The actions allowed for the user in the defined criteria comprise, for example, connecting authorized devices to the user's computing device, accessing authorized objects on the computing device and/or the network, and performing authorized input actions on the computing device and/or the network. The defined criteria are stored on the proctoring software.

The proctoring software continuously monitors the examination environment, for example, using the data capture device, for determining conformance of the user to the defined criteria. The server determines multiple transmission parameters of the server for transmitting the information related to the monitoring herein referred to as “monitoring information”. The transmission parameters comprise, for example, load, bandwidth of the server, video/audio bit rate, etc. The proctoring software transmits the monitoring information to the remote monitoring station via the server based on the determined transmission parameters. For example, in an embodiment, the proctoring software splits the monitoring information into multiple segments and transmits one or more of the segments to the remote monitoring station via the server based on the determined transmission parameters. The remote monitoring station retrieves the monitoring information from the server for playback to the proctor.

In the process of monitoring the examination environment, the proctoring software detects extraneous devices connected to the computing device, controls the data capture device for capturing the audiovisual data in the examination environment, detects access to objects on the computing device, detects input actions performed by the user on the computing device, and protects information of the selected examination. The proctoring software detects extraneous devices by, for example, detecting an attempt to connect one or more unauthorized input devices, unauthorized output devices, and unauthorized computing devices to the user's computing device by a wired mode of communication and a wireless mode of communication. The proctoring software detects objects, for example, content objects, data objects, applications, etc. accessed on the user's computing device and/or the network. The proctoring software protects the information of the selected examination herein referred to as “examination information” by, for example, disallowing tampering of the examination information on the computing device and/or the network. For example, the proctoring software protects questions of the examination from theft, unauthorized access, and alteration. The proctoring software also periodically captures information viewed by the user on a display screen of the computing device. The proctoring software further detects inactivity of the user for a predetermined period of time.

The proctor at the remote monitoring station controls the actions of the user based on the transmitted monitoring information, for example, when the user is not in conformance with the defined criteria. For example, the proctor at the remote monitoring station terminates the selected examination on the computing device when the user is not in conformance with the defined criteria, disallows access to unauthorized objects and unauthorized input actions by the user on the computing device, sends a message to notify the user of non-conformance to the defined criteria via the interface provided by the proctoring software, etc. The computer implemented method and system disclosed herein enables communication between the user of the computing device and the proctor at the remote monitoring station via the interface provided by the proctoring software through multiple modes. The computer implemented method and system disclosed herein also enables integration of the proctoring software with one or more software tools and applications required for the examination on the computing device. The computer implemented method and system disclosed herein also manages a session of the examination on the computing device to ensure that the proctoring software and one or more software tools and applications run concurrently on the computing device.

### BRIEF DESCRIPTION OF THE DRAWINGS

The foregoing summary, as well as the following detailed description of the invention, is better understood when read in conjunction with the appended drawings. For the purpose of illustrating the invention, exemplary constructions of the invention are shown in the drawings. However, the invention is not limited to the specific methods and instrumentalities disclosed herein.

FIGS. 1A-1B illustrate a computer implemented method for authenticating and monitoring an examination environment of a user.

FIG. 2 illustrates a computer implemented system for authenticating and monitoring an examination environment of a user.

FIG. 3 exemplarily illustrates the architecture of a computer system employed for authenticating and monitoring an examination environment of a user.

FIGS. 4A-4C exemplarily illustrate a flow chart comprising the steps for authenticating and monitoring an examination environment of a user.

### DETAILED DESCRIPTION OF THE INVENTION

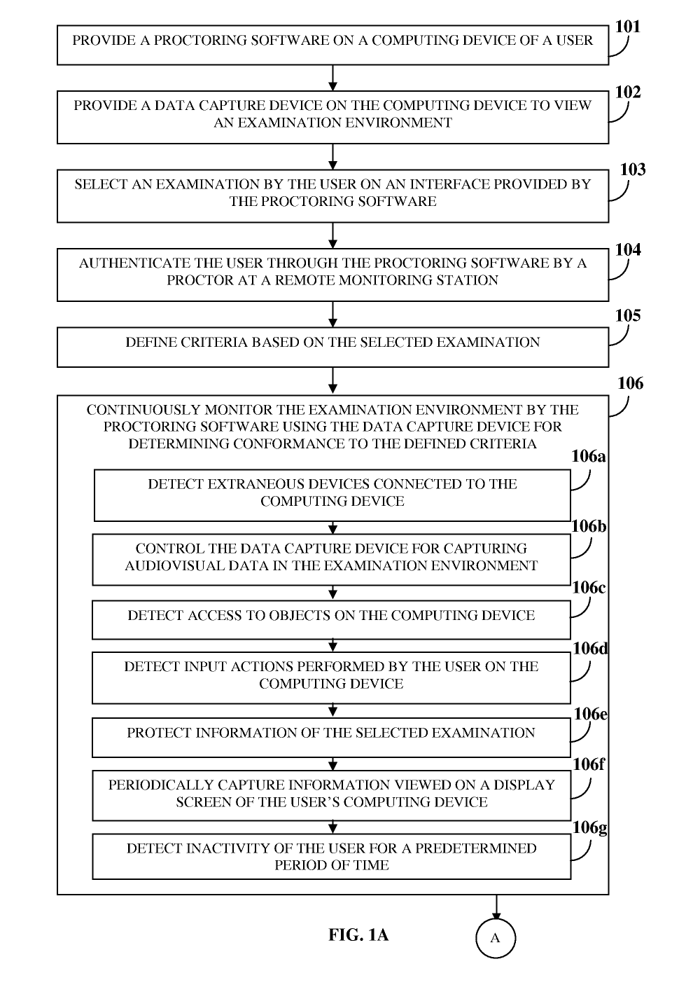

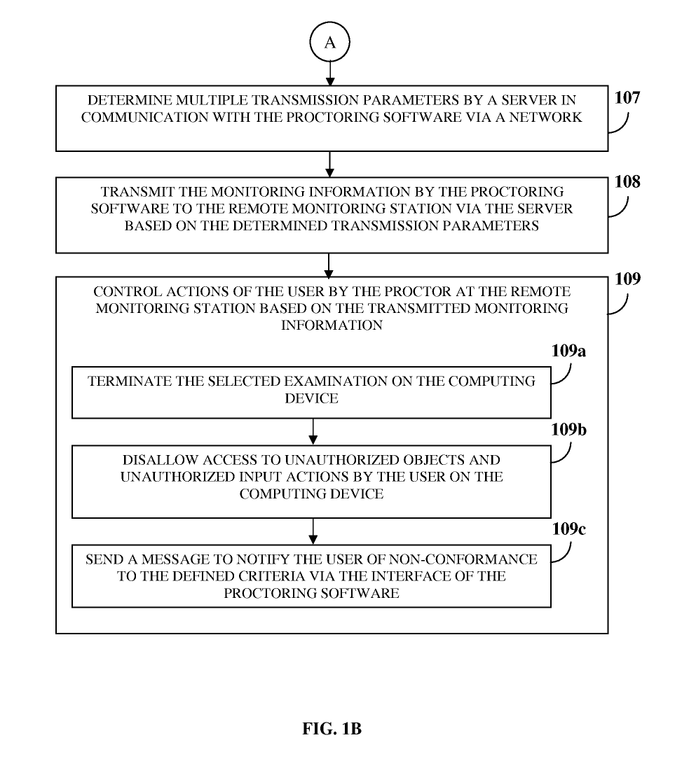

FIGS. 1A-1B illustrate a computer implemented method for authenticating and monitoring an examination environment of a user. As used herein, the term “examination environment” refers to an area surrounding the user taking an examination, which comprises the user's computing device used for the examination, hardware components, software components, other devices in and around the user's computing device, and other computer systems and networks connected to the user's computing device by wired and/or wireless modes of communication. Also, as used herein, the term “user” refers to a person taking the examination in the examination environment.

A proctoring software is provided 101 on a computing device of the user. The computing device is, for example, a desktop computer, a laptop, a tablet computing device, a mobile device, a personal digital assistant, etc. In an embodiment, the proctoring software is implemented as a secure browser application that controls access to objects in the computing device. As used herein, the term “objects” refers to any type of data or entity, for example, content objects, data objects, software, software tools, applications, etc. that can be accessed or manipulated by the user on the user's computing device and/or over a network. The proctoring software therefore prevents the user from accessing applications and other unauthorized objects that are not required for the examination. The proctoring software communicates with a remote monitoring station via a server over a network. The network is, for example, the internet, an intranet, a local area network, a wide area network, a WiFi communication network, a Bluetooth™ communication network, an infra red communication network, etc.

A data capture device is provided 102 on the computing device of the user. The data capture device is configured to rotate and tilt to multiple angles to view the examination environment and capture audiovisual data from the viewed examination environment. The data capture device is, for example, an image capture device, a video capture device, an audio capture device, or any combination thereof. The data capture device captures, for example, textual data, voice or audio data, image data, video data, etc. from the examination environment continuously. The data capture device is, for example, a webcam, a microphone, a webcam integrated with a microphone, other image capture devices, other video capture devices, other audio capture devices, etc. In an embodiment, the data capture device comprises a motor for facilitating automatic rotation and tilt of the data capture device to multiple angles to view the examination environment. The data capture device can be rotated to angles ranging, for example, from about 0 degrees to about 360 degrees and can be tilted to angles ranging, for example, from about 0 degrees to about 180 degrees.

The user selects 103 an examination on an interface provided by the proctoring software. The interface enables the user to access a list of examinations through the proctoring software. The interface provides access to, for example, a webpage listing the examinations via a browser application, for example, a web browser such as Internet Explorer® of Microsoft Corporation, Firefox® of Mozilla Corporation, etc. that retrieves, displays, and allows exchange of content resources on the world wide web. In an embodiment, the proctoring software comprises a secure browser application for enabling access to the list of examinations. A proctor is assigned to monitor the examination environment of the user based on the selected examination. The proctor may also select one or more users from a list of users taking an examination for monitoring their examination environments. The proctoring software connects the user's computing device to the remote monitoring station administered by the proctor via the server. The proctor at the remote monitoring station authenticates 104 the user through the proctoring software based on the selected examination. For example, the proctor may authenticate the user by verifying the user's credentials, verifying examination registration information, performing biometric authentication of the user's identity, etc.

The proctor defines 105 criteria for the selected examination and transmits the defined criteria to the proctoring software. The defined criteria comprise multiple actions allowed for the user while taking the selected examination in the examination environment. The actions allowed for the user in the defined criteria comprise, for example, connecting authorized devices to the computing device, accessing authorized objects such as data objects, content objects, software applications, etc. on the computing device and/or the network, performing authorized input actions on the computing device and/or the network, etc. For example, the user may be allowed a predetermined set of authorized keystrokes and computer mouse clicks to access authorized images, text, audio, video, software applications, etc. on the user's computing device, on other connected computing devices, and/or on the internet. The user may be allowed to access authorized objects on one or more computing devices and one or more networks based on the defined criteria. The defined criteria are stored on the proctoring software. In an embodiment, the user is notified of the defined criteria for the selected examination via the interface provided by the proctoring software.

The user may take the examination through the proctoring software or by installing other examination software, software applications, software tools, etc. The proctoring software integrates and/or interacts with the software tools and applications required for the examination on the computing device. The computer implemented method disclosed herein also manages a session of the examination on the computing device to ensure that the proctoring software and one or more software tools and applications run concurrently on the computing device.

The proctoring software continuously monitors 106 the examination environment, for example, using the data capture device, for determining conformance of the user to the defined criteria. During monitoring of the examination environment, the proctoring software on the computing device detects 106a extraneous devices connected to the computing device, controls 106b the data capture device for capturing the audiovisual data in the examination environment, detects 106c access to objects on the computing device, detects 106d input actions performed by the user on the computing device, protects 106e information of the selected examination information, periodically captures 106f information viewed by the user on a display screen of the user's computing device, detects 106g inactivity of the user for a predetermined period of time, etc.

The proctoring software detects an attempt to connect extraneous devices, for example, one or more unauthorized input devices such as a keyboard, a mouse, a joystick, etc., unauthorized output devices such as a monitor, a printer, etc., storage devices such as a floppy disk, a compact disc, a digital versatile disc, a memory card, etc., a device following a universal serial bus (USB) specification such as an external magnetic hard drive, an external optical drive, a portable flash drive, a card reader, a portable gaming device, a personal digital assistant, etc., and unauthorized computing devices such as a desktop computer, a laptop, tablet computers, a mobile phone, etc., by a wired mode of communication and a wireless mode of communication.

The proctoring software authenticates devices connected to the computing device of the user to prevent another user from taking an examination from a different room using a USB device such as a USB mouse, another keyboard, monitor, etc. In an embodiment, the proctor provides an identification number (ID) for each of the authorized devices to be used for the examination during definition of the criteria. The identification numbers are stored on the proctoring software. The proctoring software allows access of devices connected to the user's computing device on verifying the identification numbers of the connected devices with the identification numbers defined in the criteria. If the proctoring software detects an attempt to connect an unauthorized device, the proctoring software alerts the proctor at the remote monitoring station to terminate the examination. In another embodiment, the proctoring software disables the unauthorized devices on the computing device and does not allow the user to utilize the unauthorized devices. For example, if a user attempts to connect an additional computer mouse or keyboard on the user's desktop computer, the proctor at the remote monitoring station is alerted to take action. Furthermore, the proctoring software does not allow another user to access the user's computing device using remote desktop software applications in order to take the examination for the user.

During monitoring of the examination environment, the proctor at the remote monitoring station controls the data capture device that captures the audiovisual data in the examination environment. For example, the proctor at the remote monitoring station can send instructions to the proctoring software to rotate and tilt the data capture device, for example, the webcam, to obtain a 360 degrees pan/180 degrees tilt view of the user's examination environment. In an embodiment, the data capture device captures 360 degree view images of the user's examination environment continuously. In another embodiment, the data capture device is programmed to capture 360 degree view images of the user's examination environment at defined times. For example, the proctor defines times for capturing the image data in the examination environment and transmits instructions to the data capture device to capture the image data at the defined times.

The proctor can send instructions to the proctoring software for panning the data capture device in a left direction, a right direction, an upward direction, and a downward direction to capture a full-motion video in different views. The data capture device also captures audio information from the examination environment through, for example, a microphone integrated in a webcam on the user's computing device and transmits the audio information to the remote monitoring station.

During monitoring of the examination environment, the proctoring software also detects access to objects, for example, data objects such as text files, image files, video files, audio files, executable files, system files, etc. and applications such as software, browsers, etc., on the computing device and/or over a network. For example, the user is allowed to access only certain software applications, websites, online books, etc. based on the type of examination. The proctor defines the allowable objects in the criteria and stores the allowable objects in an access control list. The access control list is stored by the proctoring software on the user's computing device. The access control list defines, for example, the list of applications that are allowed for running on the user's computing device. On detecting access to an unauthorized object that is not specified in the defined criteria, the proctoring software alerts the proctor at the remote monitoring station to warn the user or terminate the examination. In another embodiment, the proctoring software disables access to the unauthorized objects on the computing device. The proctoring software also detects input actions such as keystrokes, button usage, computer mouse clicks, etc. performed by the user on the computing device. On detecting unauthorized actions performed by the user on the computing device that are not specified in the defined criteria, the proctoring software alerts the proctor at the remote monitoring station to warn the user or terminate the examination.

During monitoring of the examination environment, the proctoring software also protects information, for example, questions, etc. of the selected examination herein referred to as “examination information”. Protection of the examination information comprises disallowing tampering of the examination information on the user's computing device and/or the network. For example, the proctoring software protects and secures questions of the examination from theft, unauthorized access, alteration, etc. In an embodiment, the examination may be conducted and taken in the secure browser application of the proctoring software to prevent the user from accessing other applications and browsers that are not required for the examination and to prevent the user from copying the questions of the examination and disseminating the questions across the network, etc.

The monitoring of the examination environment further comprises periodically capturing information viewed on a display screen, for example, a monitor of the user's computing device. For example, the proctoring software periodically performs a screen capture of the information on the user's display screen and transmits the captured information to the remote monitoring station. The monitoring of the examination environment further comprises detecting inactivity of the user for a predetermined period of time. For example, if the user does not perform any action for about 30 minutes during an examination session, the proctoring software alerts the proctor at the remote monitoring station to terminate the examination.

The server is in communication with the proctoring software and the remote monitoring station via the network. The server determines 107 transmission parameters comprising, for example, server load, bandwidth, video and/or audio bit rate, etc. of the server for optimizing transmission of information related to the monitoring to the remote monitoring station. The information related to monitoring of the examination environment is herein referred to as “monitoring information”. As used herein, the term “load” refers to a measure of operations related to processing of information performed by the server. Also, as used herein, the term “bandwidth” refers to capacity of the server for transmitting information to the remote monitoring station and the rate at which the server can transmit the information. Also, as used herein, the term “bit rate” refers to the number of bits used per unit of playback time to represent a continuous medium such as video or audio.

The proctoring software transmits 108 the monitoring information to the remote monitoring station via the server based on the determined transmission parameters. The server receives and stores the monitoring information from the proctoring software. In an embodiment, the server archives the received and stored monitoring information. The remote monitoring station retrieves the monitoring information from the server for playback to the proctor at the remote monitoring station. The computer implemented method disclosed herein does not continuously stream the monitoring information but optimizes transmission of the monitoring information from the proctoring software to the remote monitoring station without compromising efficiency. For example, if the load on the server is very high, the proctoring software will wait for the load to reduce to an optimum level to transmit the information efficiently. In an embodiment, the proctoring software splits the monitoring information into multiple segments and transmits one or more of the segments to the remote monitoring station via the server based on the determined transmission parameters. In an embodiment, the proctoring software is configured to transmit the monitoring information to the remote monitoring station via the server for M seconds with an interval of N seconds between each transmission to optimize transmission based on the determined transmission parameters. In an embodiment, the interval between the transmissions of the monitoring information is configured to have a maximum limit.

The proctor at the remote monitoring station controls 109 actions of the user based on the transmitted monitoring information, for example, when the user is not in conformance with the defined criteria. For example, the proctor terminates 109a the selected examination on the computing device when the user is not in conformance with the defined criteria, disallows 109b access to unauthorized objects and unauthorized input actions by the user on the computing device, sends 109c a message, for example, a text message, a voice message, etc. to notify the user of non-conformance to the defined criteria via the interface provided by the proctoring software, etc. The computer implemented method disclosed herein enables communication between the user of the computing device and the proctor at the remote monitoring station via the interface provided by the proctoring software. For example, the proctor may communicate with the user using an instant messaging interface invoked by the proctoring software. The proctor may also transmit voice instructions, alerts and warnings to the user via a speaker on the user's computing device.

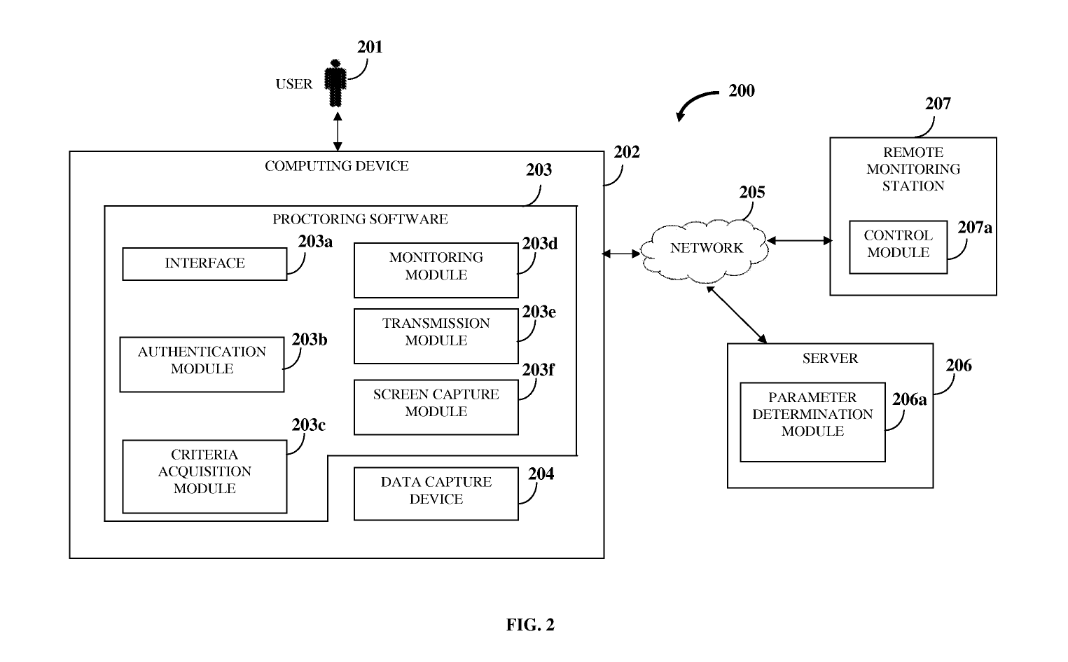

FIG. 2 illustrates a computer implemented system 200 for authenticating and monitoring an examination environment of a user 201. The computer implemented system 200 disclosed herein comprises a data capture device 204 and a proctoring software 203 provided on a computing device 202 of the user 201. The data capture device 204 is configured to rotate and tilt to multiple angles to view the examination environment and capture audiovisual data from the viewed examination environment as disclosed in the detailed description of FIG. 1. The data capture device 204 comprises a motor for facilitating automatic rotation and tilt of the data capture device 204 to, for example, angles for rotation up to about 360 degrees and angles for tilt up to about 180 degrees, to view the examination environment.

The proctoring software 203 communicates with one or more remote monitoring stations 207 via a server 206 over a network 205. The proctoring software 203 comprises an interface 203a, an authentication module 203b, a criteria acquisition module 203c, a monitoring module 203d, and a transmission module 203e. The user 201 accesses multiple examinations and selects an examination through the interface 203a. The interface 203a also enables the user 201 to communicate with a proctor at a remote monitoring station 207. The authentication module 203b authenticates the user 201 by communicating with the proctor at the remote monitoring station 207 via the network 205 based on the selected examination. The criteria acquisition module 203c acquires and stores criteria defined by the proctor for the selected examination. The defined criteria comprise multiple actions allowed for the user 201 while taking the selected examination in the examination environment. The monitoring module 203d continuously monitors the examination environment, for example, using the data capture device 204, for determining conformance of the user 201 to the defined criteria. For example, the monitoring module 203d detects extraneous devices connected to the computing device 202, controls the data capture device 204 for capturing the audiovisual data in the examination environment, detects access to objects on the computing device 202, detects input actions performed by the user 201 on the computing device 202, and protects information of the selected examination. The monitoring module 203d disallows tampering of the examination information on the computing device 202 and/or the network 205. The proctoring software 203 further comprises a screen capture module 203f. The monitoring module 203d instructs the screen capture module 203f to periodically capture information viewed by the user 201 on a display screen of the computing device 202. For example, the screen capture module 203f periodically captures a screen shot of the screen on the user's 201 desktop computer or laptop. The monitoring module 203d further detects inactivity of the user 201 for a predetermined period of time. The transmission module 203e transmits the monitoring information to the remote monitoring station 207 via the server 206 based on one or more transmission parameters determined by the server 206.

The computer implemented system 200 disclosed herein further comprises the server 206 in communication with the proctoring software 203 on the computing device 202 and the remote monitoring station 207 via the network 205. The server 206 comprises a parameter determination module 206a that determines multiple transmission parameters, for example, server load, bandwidth, video and/or audio bit rate, etc. of the server 206 for optimizing transmission of the monitoring information by the transmission module 203e of the proctoring software 203 to the remote monitoring station 207 via the network 205. The server 206 receives and stores the monitoring information from the proctoring software 203 based on the determined transmission parameters. In an embodiment, the transmission module 203e splits the monitoring information into multiple segments and transmits one or more of the segments to the remote monitoring station 207 via the server 206 based on the determined transmission parameters.

The computer implemented system 200 disclosed herein further comprises a remote monitoring station 207 in communication with the proctoring software 203 on the computing device 202 via the server 206 over the network 205. The remote monitoring station 207 retrieves the received monitoring information from the server 206 for playback at the remote monitoring station 207. The remote monitoring station 207 comprises a control module 207a. The control module 207a in communication with the proctoring software 203 on the user's 201 computing device 202 controls the actions of the user 201 based on the transmitted monitoring information, for example, when the user 201 is not in conformance with the defined criteria. For example, the control module 207a controls termination of the selected examination on the computing device 202, disallows unauthorized access to unauthorized objects and unauthorized input actions by the user 201 on the computing device 202, and/or sends a message to notify the user 201 of non-conformance to the defined criteria via the interface 203a of the proctoring software 203.

The computer implemented system 200 disclosed herein manages the examination session to ensure that the proctoring software 203 and one or more software tools and applications required for the examination run concurrently on the computing device 202. For example, the proctoring software 203 can be used with other software, for example, an Oracle® client, Tally software of Tally Solutions Pvt. Ltd., development tools, etc., on the computing device 202. The computer implemented system 200 disclosed herein provides plug-ins for the other software that maintain the integrity of the examination environment by communicating with the proctoring software 203 using a session identifier.

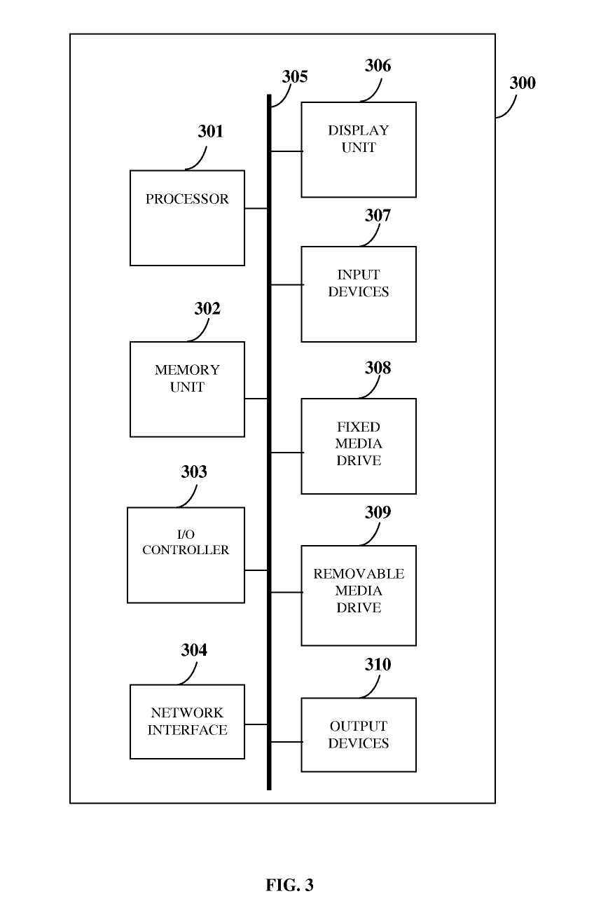

FIG. 3 exemplarily illustrates the architecture of a computer system 300 employed for authenticating and monitoring an examination environment of a user 201. The proctoring software 203 is deployed on the computer system 300 of the computing device 202. The server 206 and the remote monitoring station 207 also employ the architecture of the computer system 300 exemplarily illustrated in FIG. 3.

The proctoring software 203 communicates with the remote monitoring station 207 via a short range network or a long range network. The network 205 is, for example, a local area network (LAN), a wide area network, a mobile communication network, etc. The computer system 300 comprises, for example, a processor 301, a memory unit 302 for storing programs and data, an input/output (I/O) controller 303, a network interface 304, and a display unit 306 communicating via a data bus 305. The computer system 300 further comprises input devices 307, output devices 310, etc.

The processor 301 is an electronic circuit that executes computer programs. The memory unit 302 is used for storing programs, applications, and data. For example, the proctoring software 203 is stored on the memory unit 302 of the computer system 300. The memory unit 302 comprises, for example, a random access memory (RAM) or another type of dynamic storage device that stores information and instructions for execution by the processor 301. The memory unit 302 also stores temporary variables and other intermediate information used during execution of the instructions by the processor 301. The computer system 300 further comprises a read only memory (ROM) or another type of static storage device that stores static information and instructions for the processor 301. The network interface 304 enables connection of the computer system 300 to the network 205. The data bus 305 permits communication between the modules, for example, 203a, 203b, 203c, 203d, 203e, and 203f of the computer implemented system 200 disclosed herein.

The display unit 306 displays, via the interface 203a, the results computed by the proctoring software 203 and notifications and other information from the remote monitoring station 207 to the user 201. The input devices 307 are used for inputting data into the computer system 300. The input devices 307 are, for example, a keyboard such as an alphanumeric keyboard, a joystick, a computer mouse, a touch pad, a touch-sensitive screen, a light pen, a voice recognition system, etc. The I/O controller 303 controls the input and output actions performed by the user 201. The output devices 310, for example, a printer, receive and read digital data on a compact disk, a digital video disk or other medium.

The computer system 300 further comprises a fixed media drive 308 and a removable media drive 309 for receiving removable media. Computer applications and programs are used for operating the computer system 300. The programs are loaded onto the fixed media drive 308 and into the memory unit 302 of the computer system 300 via the removable media drive 309. In an embodiment, the computer applications and programs may be loaded directly through the network 205. Computer applications and programs are executed by double clicking a related icon displayed on the display unit 306 using one of the input devices 307. The user 201 interacts with the computer system 300 using the interface 203a displayed on the display unit 306.

The computer system 300 employs operating systems for performing multiple tasks. An operating system is responsible for management and coordination of activities and sharing of resources of the computer system 300. The operating system further manages security of the computer system 300, peripheral devices connected to the computer system 300, and network connections. The operating system employed on the computer system 300 recognizes, for example, inputs provided by the user 201 using one of the input devices 307, the output display, files and directories stored locally on the fixed media drive 308, etc. The operating system on the computer system 300 executes different programs, for example, a web browser, initiated by the user 201 using the processor 301. The operating system monitors the use of the processor 301. The operating system on the computer system 300 of the computing device 202, the server 206, and the remote monitoring station 207 executes different modules initiated by the computing device 202, the server 206, and the remote monitoring station 207 respectively using the processor 301. For example, the processor 301 retrieves instructions for executing the proctoring software 203 from the program memory in the form of signals. A program counter (PC) determines location of the instructions in the program memory. The program counter stores a number that identifies the current position in the program of the proctoring software 203. The instructions are placed in an instruction register (IR) in the processor 301. At the time of execution, the instructions stored in the instruction register are examined to determine the operations to be performed by the processor 301.

The instructions fetched by the processor 301 from the program memory, after being processed, are decoded. After processing and decoding, the processor 301 executes the instructions. For example, the authentication module 203b of the proctoring software 203 defines instructions for authenticating the user 201 based on the selected examination. The criteria acquisition module 203c defines instructions for acquiring and storing criteria defined by the proctor for the selected examination. The monitoring module 203d defines instructions for continuously monitoring the examination environment, for example, using the data capture device 204, for determining conformance of the user 201 to the defined criteria. The monitoring module 203d defines instructions for detecting extraneous devices connected to the computing device 202, controlling the data capture device 204 for capturing the audiovisual data in the examination environment, detecting access to objects on the computing device 202, detecting input actions performed by the user 201 on the computing device 202, protecting information of the selected examination, detecting inactivity of the user 201 for a predetermined period of time, etc. The screen capture module 203f defines instructions for periodically capturing information viewed on a display screen of the computing device 202. The transmission module 203e defines instructions for transmitting the monitoring information to the remote monitoring station 207 via the server 206 based on the transmission parameters determined by the server 206. The transmission module 203e also defines instructions for splitting the monitoring information into multiple segments and transmitting one or more of the segments to the remote monitoring station 207 via the server 206 based on the determined transmission parameters. The proctoring software 203 further defines instructions for facilitating automatic rotation and tilt of the data capture device 204 to multiple angles to view the examination environment. The parameter determination module 206a of the server 206 defines instructions for determining the transmission parameters of the server 206 for transmitting the monitoring information to the remote monitoring station 207. The control module 207a of the remote monitoring station 207 defines instructions for controlling the actions of the user 201 based on the transmitted monitoring information. The control module 207a defines instructions for terminating the selected examination on the computing device 202, disallowing access to unauthorized objects and unauthorized input actions by the user 201 on the computing device 202, and/or sending a message to notify the user 201 of non-conformance to the defined criteria via the interface 203a of the proctoring software 203. The defined instructions are stored in the program memory or received from a remote server.

The processor 301 of the computing device 202 retrieves the instructions defined by the authentication module 203b, the criteria acquisition module 203c, the monitoring module 203d, the transmission module 203e, and the screen capture module 203f and executes the instructions. The processor 301 of the server 206 retrieves the instructions defined by the parameter determination module 206a and executes the instructions. The processor 301 of the remote monitoring station 207 retrieves the instructions defined by the control module 207a and executes the instructions.

The operating system performs multiple routines for performing a number of tasks required to assign the input devices 307, the output devices 310, and memory for execution of the modules, for example, 203a, 203b, 203c, 203d, 203e, 203f, etc. of the computer implemented system 200 disclosed herein. The tasks performed by the operating system comprise assigning memory to the proctoring software 203 and data, moving data between memory and disk units, and handling input/output operations. The operating system performs the tasks on request by the operations and after performing the tasks, the operating system transfers the execution control back to the processor 301. The processor 301 continues the execution to obtain one or more outputs that are displayed to the user 201 on the display unit 306.

For purposes of illustration, the detailed description refers to the server 206 being run locally on a computer system 300; however the scope of the computer implemented method and system 200 disclosed herein is not limited to the server 206 being run locally on a computer system 300 via the operating system and the processor 301 but may be extended to run remotely over the network 205 by employing a web browser and a remote server, a mobile phone, or other electronic devices.

Disclosed herein is also a computer program product comprising computer executable instructions embodied in a non-transitory computer readable storage medium. As used herein, the term “non-transitory computer readable storage medium” refers to all computer readable media, for example, non-volatile media such as optical disks or magnetic disks, volatile media such as a register memory, processor cache, etc., and transmission media such as wires that constitute a system bus coupled to the processor 301, except for a transitory, propagating signal. The computer executable instructions embodied on the non-transitory computer readable storage medium which when executed by the processor 301 cause the processor 301 to perform the method steps for authenticating and monitoring an examination environment of a user 201.

The computer program product disclosed herein comprises multiple computer program codes for authenticating and monitoring the examination environment of the user 201. For example, the computer program product disclosed herein comprises a first computer program code for providing a proctoring software 203 on a computing device 202 of a user 201, a second computer program code for authenticating the user 201 through the proctoring software 203 based on an examination selected by the user 201, a third computer program code for acquiring and storing criteria defined by a proctor at the remote monitoring station 207 for the selected examination, and a fourth computer program code for continuously monitoring the examination environment for determining conformance of the user 201 to the defined criteria. The computer program product disclosed herein further comprises a fifth computer program code for detecting extraneous devices connected to the computing device 202, a sixth computer program code for controlling a data capture device 204 for capturing audiovisual data in the examination environment, a seventh computer program code for detecting access to objects on the computing device 202, an eighth computer program code for detecting input actions performed by the user 201 on the computing device 202, a ninth computer program code for protecting information of the selected examination, a tenth computer program code for periodically capturing information viewed by the user 201 on a display screen of the computing device 202, and an eleventh computer program code for detecting inactivity of the user 201 for a predetermined period of time. The computer program product disclosed herein further comprises a twelfth computer program code for transmitting the monitoring information by the proctoring software 203 to the remote monitoring station 207 via the server 206 based on multiple transmission parameters determined by the server 206. The computer program product disclosed herein further comprises a thirteenth computer program code for facilitating automatic rotation and tilt of the data capture device 204 to multiple angles to view the examination environment and a fourteenth computer program code for enabling integration of the proctoring software 203 with one or more software tools and applications required for the examination on the computing device 202. The computer program codes comprising the computer executable instructions for authenticating and monitoring the examination environment of the user 201 are embodied on the non-transitory computer readable storage medium. The processor 301 of the computer system 300 retrieves these computer executable instructions and executes them for authenticating and monitoring the examination environment of the user 201.

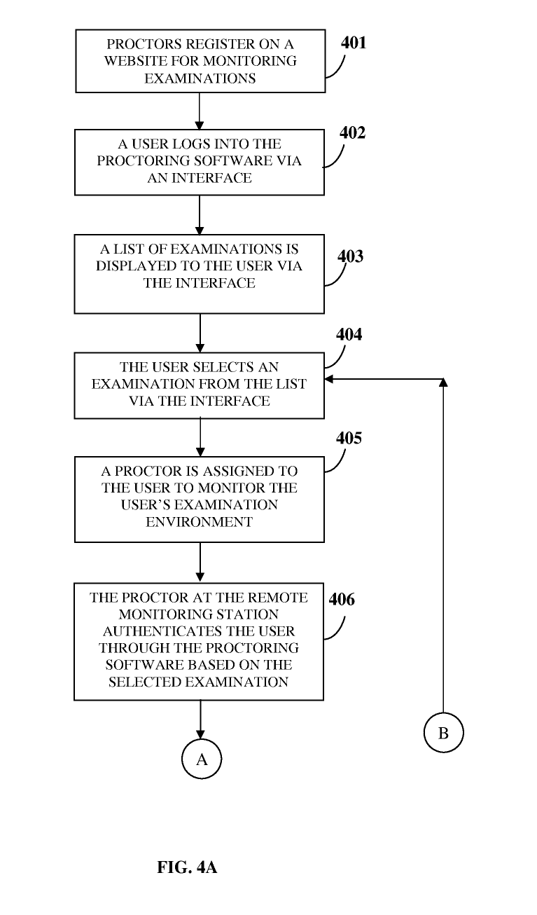

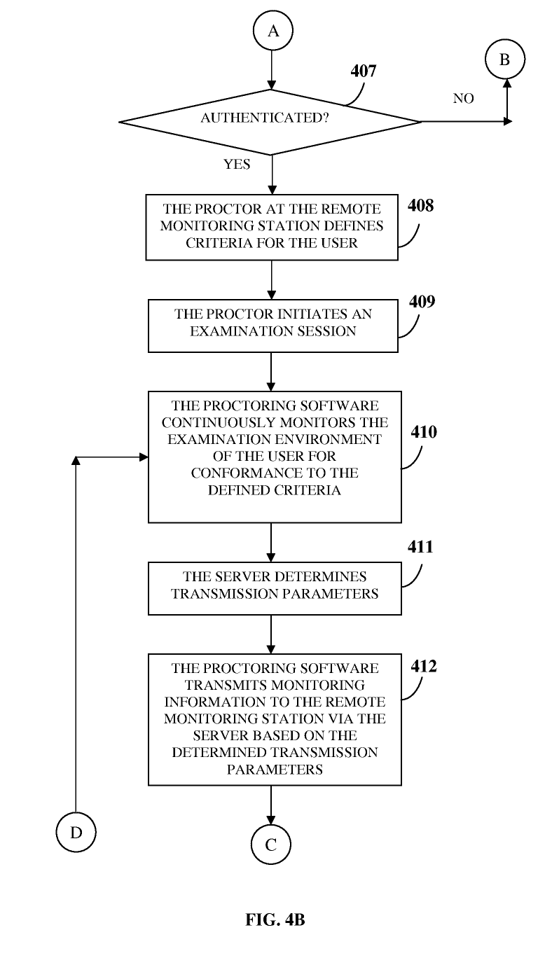

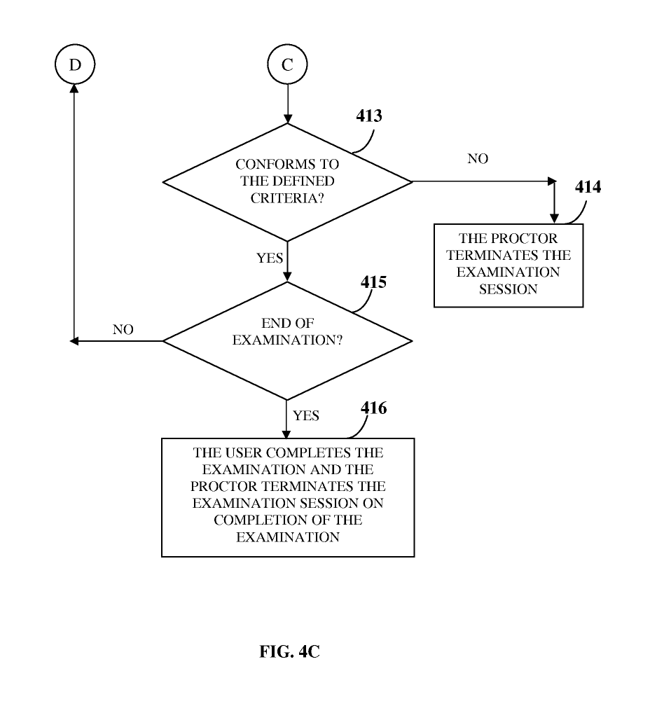

FIGS. 4A-4C exemplarily illustrate a flow chart comprising the steps for authenticating and monitoring an examination environment of a user 201. Consider an example where multiple proctors register 401 on a website for monitoring examinations hosted on the website. The user 201 logs 402 into the proctoring software 203 on the computing device 202 via an interface 203a. When the user 201 logs into the website through the proctoring software 203, the proctoring software 203 retrieves the list of examinations from the website via the network 205 and displays 403 the list to the user 201 via the interface 203a. The user 201 selects 404 examination Y from the list of examinations via the interface 203a. Proctor X from the registered proctors is assigned 405 to monitor the user's 201 examination environment based on the selected examination. Proctor X may also select one or more users from a user list on the website who are taking examination Y or any other examination to monitor their examination environments. The proctoring software 203 connects the user's 201 computing device 202 to the remote monitoring station 207 administered by proctor X via the server 206.

Proctor X at the remote monitoring station 207 authenticates 406 the user 201 through the proctoring software 203, for example, by verifying the user's 201 identity against the user's 201 biometric information and examination registration information corresponding to examination Y retrieved from the website. The biometric information comprises, for example, face recognition and iris recognition information to verify the face and iris of the user 201. If the authentication 407 fails, the session is terminated and the user 201 may be allowed to reselect an examination from the list via the interface 203a.

On successful authentication 407, Proctor X at the remote monitoring station 207 defines 408 criteria for examination Y and transmits the defined criteria to the proctoring software 203 via the network 205. For example, proctor X provides identification numbers to the user's 201 computer mouse and keyboard connected to the user's 201 computing device 202. In this example, the defined criteria comprise allowing the devices with the provided identification numbers to connect to the user's 201 computing device 202. The defined criteria also allow access of a calculator application on the user's 201 computing device 202. The defined criteria prevent the user 201 from connecting a universal serial bus (USB) device, an additional mouse, and an additional keyboard without an identification number to the user's 201 computing device 202. The defined criteria also prevent access to multimedia applications, browser applications, data files, and content files on the user's 201 computing device 202 and/or the network 205. The defined criteria also allow the user 201 to access only the alphanumeric keys and symbols of the keyboard, and prevent selective keystrokes comprising a combination of CTRL and C keys, a combination of CTRL and V keys, and a combination of CTRL and Z keys for copying and pasting questions of the examination on the computing device 202 or disseminating the questions to other users on the network 205.

The proctoring software 203 initiates 409 a session for examination Y. The proctoring software 203 continuously monitors 410 the examination environment of the user 201 for conformance of the user 201 to the defined criteria. The server 206 determines 411 transmission parameters of the server 206. For example, the server 206 determines server load to be 0.20 and bandwidth to be 256 kilobits per second (kbps). The proctoring software 203 transmits 412 the monitoring information, for example, the video and audio information of the examination environment to the remote monitoring station 207 via the server 206 based on the determined transmission parameters for N seconds with a gap of M seconds. N is the time duration for continuously transmitting the video and audio information. M is the time interval between transmissions of the video and audio information. Consider N to be seven seconds and M to be three seconds. If the server load increases or there is bandwidth congestion, the server 206 instructs the proctoring software 203 to change the values of N and M accordingly. The server 206 defines a limit on the maximum value of M since the period for which video and audio information is not transmitted cannot be above a maximum threshold, for example, five seconds. For example, the server 206 defines the limit on the maximum value of M to be five seconds. The proctoring software 203 varies the video and audio bit rate for transmission based on the determined load and bandwidth without compromising on clarity of the video and audio information. The server 206 also defines a minimum threshold for the video and audio bit rate. The proctoring software 203 cannot decrease the video and audio bit rate below the minimum threshold in order to maintain a desired level of clarity of the video and audio information.

A webcam integrated with a microphone and attached to a motor on the user's 201 computing device 202 monitors the examination environment of the user 201 by rotating from an angle of 0 degrees to 360 degrees and tilting from an angle of 0 degrees to 180 degrees. The webcam captures audiovisual data of the examination environment and transmits the audiovisual data to the remote monitoring station 207 via the server 206. Proctor X at the remote monitoring station 207 monitors conformance 413 of the user 201 to the defined criteria. If the user 201 conforms to the criteria until the end of the examination Y 415, the user 201 is allowed to complete the examination and the proctor terminates 416 the examination session on completion of examination Y. However, while taking examination Y, if the user 201 attempts to access an informational website on a browser application and attempts to connect a USB device to the computing device 202, the proctoring software 203 determines non-conformance to the defined criteria and alerts the proctor X at the remote monitoring station 207. Proctor X then sends a message to the user 201 regarding the termination 414 of the examination session for examination Y.

It will be readily apparent that the various methods and algorithms disclosed herein may be implemented on computer readable media appropriately programmed for general purpose computers and computing devices. As used herein, the term “computer readable media” refers to non-transitory computer readable media that participate in providing data, for example, instructions that may be read by a computer, a processor or a like device. Non-transitory computer readable media comprise all computer readable media, for example, non-volatile media, volatile media, and transmission media, except for a transitory, propagating signal. Non-volatile media comprise, for example, optical disks or magnetic disks and other persistent memory volatile media including a dynamic random access memory (DRAM), which typically constitutes a main memory. Volatile media comprise, for example, a register memory, processor cache, a random access memory (RAM), etc. Transmission media comprise, for example, coaxial cables, copper wire and fiber optics, including the wires that constitute a system bus coupled to a processor. Common forms of computer readable media comprise, for example, a floppy disk, a flexible disk, hard disk, magnetic tape, any other magnetic medium, a compact disc-read only memory (CD-ROM), digital versatile disc (DVD), any other optical medium, punch cards, paper tape, any other physical medium with patterns of holes, a random access memory (RAM), a programmable read only memory (PROM), an erasable programmable read only memory (EPROM), an electrically erasable programmable read only memory (EEPROM), a flash memory, any other memory chip or cartridge, or any other medium from which a computer can read. A “processor” refers to any one or more microprocessors, central processing unit (CPU) devices, computing devices, microcontrollers, digital signal processors or like devices. Typically, a processor receives instructions from a memory or like device, and executes those instructions, thereby performing one or more processes defined by those instructions. Further, programs that implement such methods and algorithms may be stored and transmitted using a variety of media, for example, the computer readable media in a number of manners. In an embodiment, hard-wired circuitry or custom hardware may be used in place of, or in combination with, software instructions for implementation of the processes of various embodiments. Thus, embodiments are not limited to any specific combination of hardware and software. In general, the computer program codes comprising computer executable instructions may be implemented in any programming language. Some examples of languages that can be used comprise C, C++, C#, Perl, Python, or JAVA. The computer program codes or software programs may be stored on or in one or more mediums as an object code. The computer program product disclosed herein comprises computer executable instructions embodied in a non-transitory computer readable storage medium, wherein the computer program product comprises computer program codes for implementing the processes of various embodiments.

The present invention can be configured to work in a network environment including a computer that is in communication, via a communications network, with one or more devices. The computer may communicate with the devices directly or indirectly, via a wired or wireless medium such as the Internet, a local area network (LAN), a wide area network (WAN) or the Ethernet, token ring, or via any appropriate communications means or combination of communications means. Each of the devices may comprise computers such as those based on the Intel® processors, AMD® processors, UltraSPARC® processors, Sun® processors, IBM® processors, etc. that are adapted to communicate with the computer. Any number and type of machines may be in communication with the computer.

The foregoing examples have been provided merely for the purpose of explanation and are in no way to be construed as limiting of the present invention disclosed herein. While the invention has been described with reference to various embodiments, it is understood that the words, which have been used herein, are words of description and illustration, rather than words of limitation. Further, although the invention has been described herein with reference to particular means, materials, and embodiments, the invention is not intended to be limited to the particulars disclosed herein; rather, the invention extends to all functionally equivalent structures, methods and uses, such as are within the scope of the appended claims. Those skilled in the art, having the benefit of the teachings of this specification, may effect numerous modifications thereto and changes may be made without departing from the scope and spirit of the invention in its aspects.

We claim:

1. A computer implemented method for authenticating and monitoring an examination environment of a user, comprising:
providing a proctoring software on a computing device of said user, wherein said proctoring software communicates with a remote monitoring station via a server over a network;
providing a data capture device on said computing device of said user, wherein said data capture device is configured to rotate and tilt to a plurality of angles to view said examination environment and capture audiovisual data from said viewed examination environment;
authenticating said user through said proctoring software by a proctor at said remote monitoring station;
defining criteria by said proctor for an examination selected by said user, wherein said defined criteria comprise a plurality of actions allowed for said user while taking said selected examination in said examination environment, wherein said defined criteria are stored on said proctoring software;
continuously monitoring said examination environment by said proctoring software using said data capture device for determining conformance of said user to said defined criteria;
determining a plurality of transmission parameters by said server for transmitting information related to said monitoring;
transmitting said information related to said monitoring by said proctoring software to said remote monitoring station via said server based on said determined transmission parameters; and
controlling said actions of said user by said proctor at said remote monitoring station based on said transmitted information related to said monitoring.

2. The computer implemented method of claim 1, wherein said user selects said examination on an interface provided by said proctoring software, wherein said proctoring software connects said computing device of said user to said remote monitoring station administered by said proctor via said server, wherein said proctor authenticates said user through said proctoring software based on said selected examination.

3. The computer implemented method of claim 2, wherein said interface provided by said proctoring software enables said user to access to a plurality of examinations through said proctoring software.

4. The computer implemented method of claim 1, wherein said monitoring of said examination environment comprises one or more of:
detecting extraneous devices connected to said computing device;
controlling said data capture device for capturing said audiovisual data in said examination environment;
detecting access to objects on said computing device;
detecting input actions performed by said user on said computing device; and
protecting information of said selected examination.

5. The computer implemented method of claim 4, wherein said detection of said extraneous devices comprises detecting an attempt to connect one or more unauthorized input devices, unauthorized output devices, and unauthorized computing devices to said computing device of said user by a wired mode of communication and a wireless mode of communication.

6. The computer implemented method of claim 4, wherein said objects comprise content objects, data objects, and applications accessed on one or more of said computing device and a network.

7. The computer implemented method of claim 4, wherein said protection of said information of said selected examination comprises disallowing tampering of said information of said selected examination on one or more of said computing device and said network.

8. The computer implemented method of claim 1, wherein said monitoring of said examination environment comprises periodically capturing information viewed by said user on a display screen of said computing device.

9. The computer implemented method of claim 1, wherein said monitoring of said examination environment comprises detecting inactivity of said user for a predetermined period of time.

10. The computer implemented method of claim 1, wherein said transmission parameters comprise one or more of load, bandwidth, and video and/or audio bit rate of said server.

11. The computer implemented method of claim 1, wherein said transmission of said information related to said monitoring by said proctoring software further comprises splitting said information related to said monitoring into a plurality of segments and transmitting one or more of said segments to said remote monitoring station via said server based on said determined transmission parameters.

12. The computer implemented method of claim 1, wherein said data capture device is one of an image capture device, a video capture device, an audio capture device, and any combination thereof.

13. The computer implemented method of claim 1, wherein said data capture device is one of a webcam, a microphone, and a webcam integrated with a microphone.

14. The computer implemented method of claim 1, wherein said data capture device comprises a motor for facilitating automatic rotation and tilt of said data capture device to said angles to view said examination environment, wherein said angles for said rotation comprise angles up to about 360 degrees and said angles for tilt comprise angles up to about 180 degrees.

15. The computer implemented method of claim 1, wherein said actions allowed for said user in said defined criteria comprises connecting authorized devices to said computing device, accessing authorized objects on one or more of said computing device and said network, and performing authorized input actions on one or more of said computing device and said network.

16. The computer implemented method of claim 1, wherein said controlling of said actions of said user by said proctor, comprises one or more of:
terminating said selected examination on said computing device, when said user is not in conformance with said defined criteria;
disallowing access to unauthorized objects and unauthorized input actions by said user on said computing device; and
sending a message to notify said user of non-conformance to said defined criteria via an interface of said proctoring software.

17. The computer implemented method of claim 1, further comprising enabling communication between said user of said computing device and said proctor at said remote monitoring station, via an interface provided by said proctoring software.

18. The computer implemented method of claim 1, further comprising managing a session of said examination on said computing device to ensure that said proctoring software and one or more software tools and applications run concurrently on said computing device.

19. The computer implemented method of claim 1, further comprising integrating said proctoring software with one or more software tools and applications required for said examination on said computing device.

20. A computer implemented system for authenticating and monitoring an examination environment of a user, comprising:
a data capture device on a computing device of said user, wherein said data capture device is configured to rotate and tilt to a plurality of angles to view said examination environment and capture audiovisual data from said viewed examination environment;
a proctoring software on said computing device of said user, wherein said proctoring software comprises:
an authentication module that authenticates said user by communicating with a proctor at a remote monitoring station via a network;
a criteria acquisition module that acquires and stores criteria defined by said proctor for an examination selected by said user, wherein said defined criteria comprise a plurality of actions allowed for said user while taking said selected examination in said examination environment;
a monitoring module that continuously monitors said examination environment using said data capture device for determining conformance of said user to said defined criteria; and
a transmission module that transmits information related to said monitoring to said remote monitoring station via a server over said network based on a plurality of transmission parameters determined by said server;
said server in communication with said proctoring software and said remote monitoring station via said network, wherein said server comprises a parameter determination module that determines said transmission parameters for transmitting said information related to said monitoring by said transmission module of said proctoring software to said remote monitoring station via said network; and
said remote monitoring station in communication with said proctoring software via said server over said network, wherein said remote monitoring station comprises a control module that controls said actions of said user based on said transmitted information related to said monitoring.

21. The computer implemented system of claim 20, wherein said data capture device comprises a motor for facilitating automatic rotation and tilt of said data capture device to said angles to view said examination environment, wherein said angles for said rotation comprise angles up to about 360 degrees and said angles for tilt comprise angles up to about 180 degrees.

22. The computer implemented system of claim 20, wherein said proctoring software further comprises an interface that enables said user to access a plurality of examinations and to select said examination, wherein said interface further enables said user to communicate with said proctor at said remote monitoring station.

23. The computer implemented system of claim 20, wherein said monitoring module performs one or more of:
detecting extraneous devices connected to said computing device;
controlling said data capture device for capturing said audiovisual data in said examination environment;
detecting access to objects on said computing device, wherein said objects comprise content objects, data objects, and applications accessed on one or more of said computing device and a network;
detecting input actions performed by said user on said computing device;
protecting information of said selected examination, wherein tampering of said information of said selected examination is disallowed on one or more of said computing device and said network;
periodically capturing information viewed by said user on a display screen of said computing device; and
detecting inactivity of said user for a predetermined period of time.

24. The computer implemented system of claim 20, wherein said transmission module splits said information related to said monitoring into a plurality of segments and transmits one or more of said segments to said remote monitoring station via said server based on said determined transmission parameters, wherein said transmission parameters comprise one or more of load, bandwidth, and video and/or audio bit rate of said server.

25. The computer implemented system of claim 20, wherein said control module controls said actions of said user by one or more of:
terminating said selected examination on said computing device;
disallowing access to unauthorized objects and unauthorized input actions by said user on said computing device; and
sending a message to notify said user of non-conformance to said defined criteria via an interface of said proctoring software.

26. A computer program product comprising computer executable instructions embodied in a non-transitory computer readable storage medium, wherein said computer program product comprises:
a first computer program code for providing a proctoring software on a computing device of a user, wherein said proctoring software communicates with a remote monitoring station via a server over a network;
a second computer program code for authenticating said user through said proctoring software based on an examination selected by said user;
a third computer program code for acquiring and storing criteria defined by a proctor at said remote monitoring station for said selected examination, wherein said defined criteria comprise a plurality of actions allowed for said user while taking said selected examination in said examination environment;
a fourth computer program code for continuously monitoring said examination environment for determining conformance of said user to said defined criteria, comprising:
a fifth computer program code for detecting extraneous devices connected to said computing device;
a sixth computer program code for controlling a data capture device for capturing audiovisual data in said examination environment;
a seventh computer program code for detecting access to objects on said computing device, wherein said objects comprise content objects, data objects, and applications accessed on one or more of said computing device and a network;
an eighth computer program code for detecting input actions performed by said user on said computing device;
a ninth computer program code for protecting information of said selected examination;
a tenth computer program code for periodically capturing information viewed by said user on a display screen of said computing device; and
an eleventh computer program code for detecting inactivity of said user for a predetermined period of time; and
a twelfth computer program code for transmitting information related to said monitoring by said proctoring software to said remote monitoring station via said server based on a plurality of transmission parameters determined by said server, wherein said remote monitoring station controls said actions of said user based on said transmitted information related to said monitoring.

27. The computer program product of claim 26, further comprising a thirteenth computer program code for facilitating automatic rotation and tilt of said data capture device to a plurality of angles to view said examination environment, wherein said angles for said rotation comprise angles up to about 360 degrees and said angles for tilt comprise angles up to about 180 degrees.

28. The computer program product of claim 26, further comprising a fourteenth computer program code for enabling integration of said proctoring software with one or more software tools and applications required for said examination on said computing device.
